(19) United States
(12) Patent Application Publication
(10) Pub. No.: US 2023/0334243 A1
(43) Pub. Date: Oct. 19, 2023

(54) Document Processing Method And Information Processing Device

(71) Applicant: LegalOn Technologies, Inc., Tokyo (JP)

(72) Inventors: Ruka FUNAKI, Tokyo (JP); Tomohiro OKUMURA, Tokyo (JP); Yuya WATANABE, Tokyo (JP)

(21) Appl. No.: 18/338,400

(22) Filed: Jun. 21, 2023

Related U.S. Application Data
(63) Continuation of application No. PCT/JP2020/047929, filed on Dec. 22, 2020.

(51) Int. Cl. G06F 40/279; G06F 40/258

(52) U.S. Cl. CPC G06F 40/279; G06F 40/258

(57) ABSTRACT

A document processing method is provided for causing a processor to execute a process. The document processing method includes: confirming whether the extracted order letters are in an ascending order and serially numbered according to a predetermined rule in the document information, the order letters being extracted form units information and defining an order of the units information in the document information, the units information being generated by diving the document information by a predetermined unit; and outputting alert information including a correction candidate which shows the order letters being in the ascending order and serially numbered.

This application is a continuation of International Application No. PCT/JP2020/047929, filed on Dec. 22, 2020, which designates the United States, and the entire contents of which are incorporated herein by reference.

### FIELD

Embodiments described herein relate generally to a document processing method and an information processing device.

### BACKGROUND

Conventionally, an information processing device capable of correcting serial numbers that are disturbed in sequence by document editing work with a simple input operation has been developed to prevent input mistakes and to simplify and speeding up the rearrangement of serial numbers. For example, see Japanese Patent Publication No. H07-271793.

The information processing device disclosed in Japanese Patent Publication No. H07-271793 includes a serial number area setting module that specifies a serial number area to which serial numbers are to be assigned, a serial number order storage unit that stores multiple forms of serial numbers and that stores the numbers or specific symbols in the forms in a predetermined order, a serial number form selection module that selects a form to be used for the serial numbers, a serial number condition setting module that sets a condition for assigning the serial numbers, and a document editing module. If the order of the serial numbers already input in the serial number area is disturbed, the document editing module sequentially inputs the numbers or specific symbols with the form selected by the serial number form selection module to predetermined positions in the serial number area, and reassigns the serial numbers, according to a predetermined order of the stored form to satisfy the set condition.

### SUMMARY

According to an aspect of an embodiment, a document processing method includes confirming whether order letters are in an ascending order and serially numbered according to a predetermined rule in document information, the order letters being extracted from units information and defining an order of the units information in the document information, and the units information being generated by dividing the document information by a predetermined unit; and outputting an alert information including a correction candidate which shows the order letters are in ascending order and serially numbered.

### BRIEF DESCRIPTION OF THE DRAWINGS

FIG. 1 is a schematic diagram illustrating an example of a configuration of a document processing system according to an embodiment;

FIG. 2 is a block diagram illustrating a configuration example of a document processing server device according to the embodiment;

FIG. 3 is a schematic diagram illustrating a configuration example of document information;

FIG. 4 is a schematic diagram illustrating a configuration example of unit information;

FIG. 5 is a schematic diagram illustrating a configuration example of a screen displayed on a display unit of a terminal; and

FIG. 6 is a flowchart illustrating an operation example of the document processing server device.

### DETAILED DESCRIPTION

Hereinafter, an embodiment of the present disclosure will be described in detail with reference to the accompanying drawings. Note that the present invention is not limited to the following embodiment.

### Configuration of Document Processing System

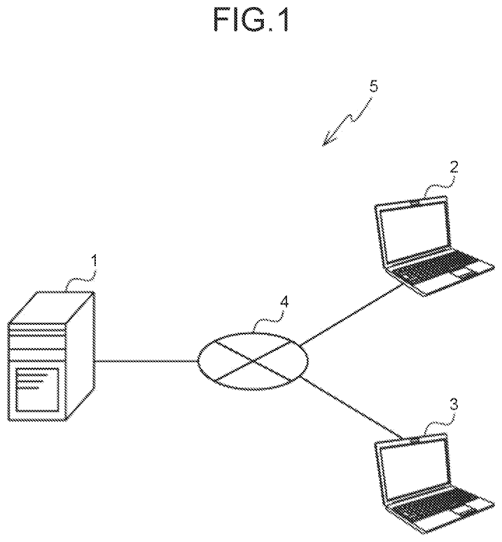

FIG. 1 is a schematic diagram illustrating an example of a configuration of a document processing system according to an embodiment.

In a document processing system 5 according to the embodiment, a document processing server device 1, a terminal 2, and a terminal 3 are communicably connected with each other via a network 4. For example, the terminal 2 is operated by a user who wishes to manage a document, create a document, confirm the content of a document, and/or review a document, and the terminal 3 is operated by another user. For example, the user of the terminal 2 and the user of the terminal 3 deal with a contract as document information and confirm the contents of the contract, and use the document processing system 5 to manage the document information created by one or both users, and to confirm and correct an error in the article number in the created document information.

The document processing server device 1 may be a server-type information processing device, and may be operated in response to a request from the terminal 2 and the terminal 3. The main body of the document processing server device 1 may include electronic components such as a Central Processing Unit (CPU) having functions for processing information, a hard disk drive (HDD), and a flash memory. The document processing server device 1 may be composed of a single information processing device, cooperatively operated by a plurality of the information processing devices, or operated by any cloud service. Moreover, the functions of the document processing server device 1 may be implemented within the terminal 2 and/or terminal 3.

The terminal 2 and terminal 3 may be information processing devices such as Personal Computers (PCs) and tablet terminals. The main body of the terminal 2 and terminal 3 may include electronic components such as a CPU having functions for processing information and a flash memory.

The network 4 may be a communication network capable of high-speed communication. For example, the network 4 may be a wired or wireless communication network such as the Internet, an intranet, and a Local Area Network (LAN).

In the above configuration, for example, a document to be processed by the document processing server device 1 may be a document in the legal field such as a contract. The users may be not legal experts but need to draft a contract, employees in the in-house legal department, or legal experts such as a lawyer who has knowledge in drafting contracts.

A user may manage document information in the document processing server device 1, by first uploading the document information from the terminal 2 or terminal 3 to the document processing server device 1, and may confirm the contents of the document information or the like by accessing the document processing server device 1 from the terminal 2 or terminal 3. To reduce the user's workload of confirming the content, or to support the user in creating a contract, the document processing server device 1 may divide the text in the document information into predetermined units, extracts letters indicating the order of the units (hereinafter referred to as “order letters”), may confirm whether the order letters are in ascending order and serially numbered according to a predetermined rule, and may output an alert when the order letters are not in ascending order and serially numbered. Moreover, in a case when the order letter is referred to in the text within each unit, and when the reference destination is an object to be alerted, the document processing server device 1 may output an alert when the reference destination is not present. A specific example of a display method of the output alert will be described below. Moreover, in the following, a clause is sometimes referred to as an “article”. Hereinafter, the embodiment will be described.

In the drawing, the terminal 2 and terminal 3 are illustrated in a single form. However, a plurality of the terminals 2 and terminals 3 may be connected to the network 4. Similarly, the terminals 2 and terminals 3 may be operated by a plurality of users.

### Configuration of Document Processing Server Device

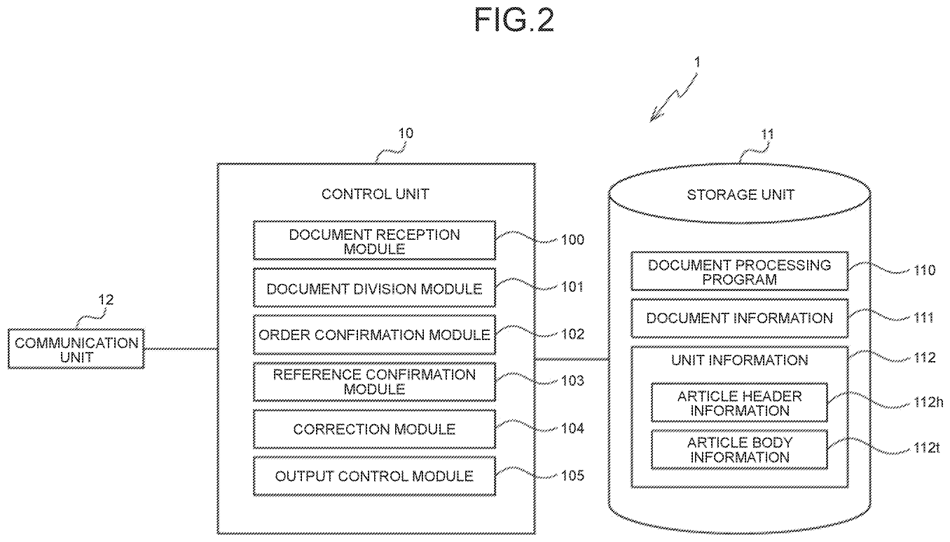

FIG. 2 is a block diagram illustrating a configuration example of the document processing server device 1 according to the embodiment.

The document processing server device 1 may include a control unit 10 that has a CPU or the like, that controls each unit, and that executes various computer programs; a storage unit 11 that includes a storage medium such as a flash memory and that stores information; and a communication unit 12 that is used as a communication interface for communicating with the outside via the network 4.

The control unit 10 may include a processor such as a CPU, and may be electrically connected to the storage unit 11 including a memory, and the communication unit 12 that is used as a communication interface. By executing a document processing program 110, which will be described below, the control unit 10 may function as a document reception module 100, a document division module 101, an order confirmation module 102, a reference confirmation module 103, a correction module 104, an output control module 105, or the like.

For example, the document reception module 100 may receive a contract from the terminal 2 or terminal 3 as document information 111, and store the received document information in the storage unit 11. The document information 111 may be image information such as a Portable Document Format (PDF) in which text is laid out, or may be information such as a text file containing text data, and a Word file. If the document information 111 is information other than text, the document reception module 100 may convert the document information 111 into text by Optical Character Recognition (OCR) or the like.

The document division module 101 may divide the document information 111 into components of a contract such as a title, a preface, and article units, and store the components in the storage unit 11 as unit information 112. The article unit may be articles, sections and items. The article unit may also be a unit divided into letters, numerals, symbols, or the like according to any rule. The document division module 101 may manage the divided unit information 112, by dividing the unit information 112 into article header information 112h that includes letters (order letters) for defining the order of articles, sections, items, or the like, and/or text to be paired with the order letter such as an article title; and article body information 112t that indicates the contents of the unit information 112 other than the article header information 112h.

The order confirmation module 102 may confirm whether the article header information 112h is in ascending order and serially numbered, according to the arrangement of the unit information 112 divided by the document division module 101 in the document information 111, and the output control module 105 may output an alert to the unit information 112 of the order letter that is not in ascending order and serially numbered. The ascending order and serial number may be confirmed according to predetermined conditions, and are not limited to general ascending order and serial number. Moreover, the article header information 112h may be prepared for each level of components such as articles, sections, and items. Whether the article header information 112h is in ascending order and serially numbered may be confirmed at each level. That is, the order confirmation module 102 may confirm whether the order letters in the articles are in ascending order and serially numbered, confirm whether the order letters in the sections are in ascending order and serially numbered, and confirm whether the order letters in the items are in ascending order and serially numbered.

The reference confirmation module 103 may search the order letters that are referred to in the article body information 112t of the unit information 112, and when the order letter that is confirmed not to be in ascending order and serially numbered by the order confirmation module 102 is referred to, the output control module 105 may output an alert to the order letter in the article body information 112t. The reference confirmation module 103 may search the order letters that are referred to in the article body information 112t in the unit information 112, and when the order letter that is not used in the article header information 112h is referred to, the output control module 105 outputs an alert to the order letter in the article body information 112t.

The correction module 104 may present a correction candidate for the order letter to which an alert is output by the confirmation operation of the order confirmation module 102 and the reference confirmation module 103. When a correction instruction is issued, the correction module 104 may correct the order letter using the correction candidate. The correction candidate may be presented such that the order letters are in ascending order and serially numbered based on predetermined conditions.

The output control module 105 may control the output of the document information 111 and the unit information 112 of the storage unit 11 as well as the output results of the units 100 to 104 to the output units of the terminal 2 and terminal 3 in a predetermined method. The details of the display method of the output alert will be described below.

The storage unit 11 may include a memory such as a flash memory, and may be electrically connected to the control unit 10 including a processor or the like, and the communication unit 12 may be as a communication interface. The storage unit 11 may store the document processing program 110, the document information 111, the unit information 112, or the like for operating the control unit 10 as each of the units 100 to 105 described above. The unit information 112 may include the article header information 112h that is the article number of the article (may also include the number of components at the level other than the articles such as sections and items) and/or the article title; and the article body information 112t that is information other than the article header information 112h in the unit information 112.

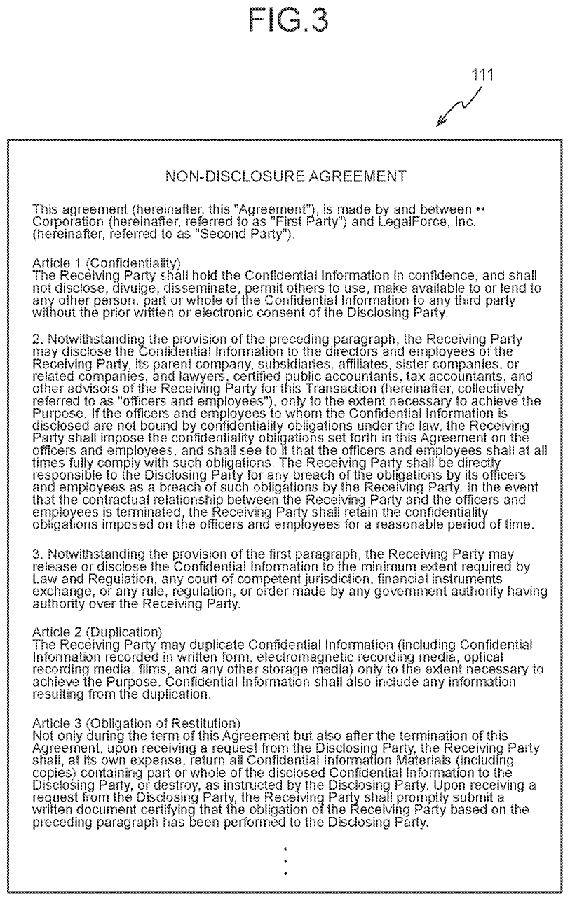

FIG. 3 is a schematic diagram illustrating a configuration example of the document information 111.

For example, the document information 111 is a contract, and includes the contents agreed between the parties. The document information 111 may include a contract title, a preface, single or multiple contract clauses, and detailed information (including seals) of the contracting parties.

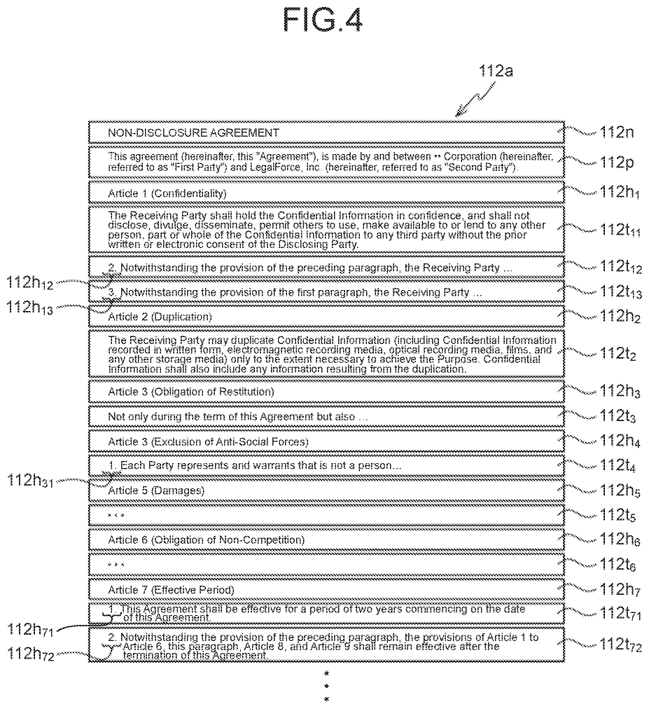

FIG. 4 is a schematic diagram illustrating a configuration example of the unit information 112.

The unit information 112a may be the result of dividing the document information 111 by the document division module 101, and include a contract title 112n, a preface 112p, article headers 112h₁ to 112h₇ . . . corresponding to the article numbers, article headers 112h₁₂, 112h₁₃, 112h₃₁, 112h₇₁, 112h₇₂ . . . corresponding to the section numbers, and article bodies 112t₁₁, 112t₁₂, 112t₁₃, 112t₂ to 112t₆, 112t₇₁, 112t₇₂ . . .

### Operation of Document Processing System

Next, an operation of the embodiment will be described. Hereinafter, an operation is described by setting the terminal 2 as an object to be operated. When the same operation is performed even if the object to be operated is switched to the terminal 3, the description thereof will be omitted.

### (1) Basic Operation

First, the user may operate the terminal 2 to login to the service provided by the document processing server device 1. Upon receiving an input of information such as a user ID and password from the user, the terminal 2 may transmit an authentication request to the document processing server device 1 along with the information.

Upon receiving the authentication request from the terminal 2 along with the information such as the user ID and password, the document processing server device 1 may refer to the user information including the user ID, password, or the like registered in advance, and authenticate the user as a user.

Next, after having logged into the service, the user may operate the terminal 2 to upload the document information of the contract, to the document processing server device 1. The terminal 2 may upload the document information to the document processing server device 1.

### (2) Order Confirmation Operation

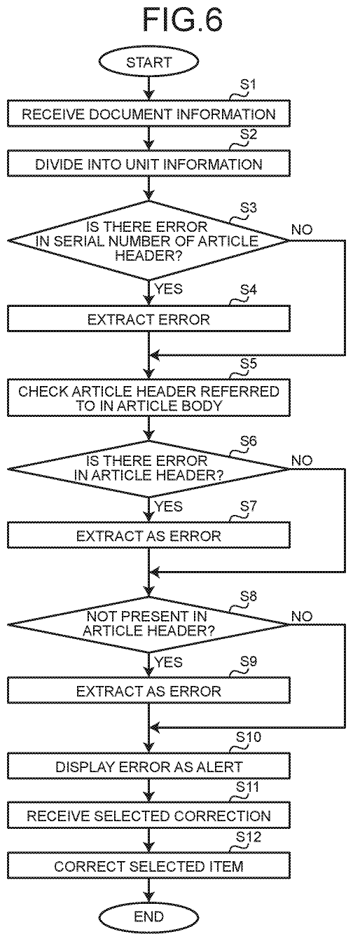

FIG. 6 is a flowchart illustrating an operation example of the document processing server device 1.

The document reception module 100 of the document processing server device 1 may receive the document information 111 corresponding to a contract from the terminal 2 operated by the user, and store the received document information 111 in the storage unit 11 (S1).

Next, the document division module 101 of the document processing server device 1 may divide the document information 111 into components of the contract serving as the unit information 112 (S2). For example, the document information 111 may be text data or data created using word processing software. The document information 111 may also be image information such as a PDF file including a scanned contract. When the document information 111 is scanned data, the document division module 101 may first convert the document information 111 into text using a method such as Optical Character Reader (OCR). Next, the document division module 101 may divide the text-converted information into components at each level, such as a contract title, a preface, article units, section units, item units . . . (In the example of FIG. 4, all units of the articles and sections are equally divided. However, the units may also be divided into articles, and when the article contains sections and items, the sections and items may be divided in the article). The document division module 101 may also divide the target document information 111 into higher order units or lower order units. Units suitable for the structure of the document information 111 may be used as the unit information 112. The division described above may be performed using techniques such as machine learning and regular expressions.

At step S2 described above, the document division module 101 may manage the divided unit information 112, by dividing the unit information 112 into the article header information 112h that includes the order letters of the articles, sections, items, or the like and/or the text to be paired with the order letter such as an article title; and the article body information 112t that indicates the contents of the unit information 112.

In the above, an example of dividing the document information 111 into the unit information 112 has been described. However, as an operation of the order confirmation module 102, which will be described below, the document information 111 may need not be divided, and the article (section, item) unit may be treated as a range of text, and a part (or only order letters) corresponding to the article header information 112h may be extracted from the range. Similarly, the target of the article body information 112t may also be a portion other than the part (or only order letters) corresponding to the article header information 112h in the text within the range described above.

The method of extracting the order letters and letters corresponding to the order letters when the document information 111 is not divided, includes a method of finding out a title by pattern matching using regular expressions, a method of extracting a title using sequence labeling based on machine learning, or the like.

Next, the order confirmation module 102 may confirm whether there is any error by confirming whether the article header information 112h is in ascending order and serially numbered according to the arrangement of the unit information 112 divided by the document division module 101 in the document information 111 (S3). If there is an error in the serial number of the article header information 112h (Yes at S3), the order confirmation module 102 may extract the article header information 112h as an error (S4). For example, “Article 3” is given to the article header 112h₄ illustrated in FIG. 4, where “Article 4” should be given if it is in ascending order and serially numbered. Hence, the article header 112h₄ may be extracted as an error. The ascending order and serial number may be the general ascending order and serial number such as 1, 2, 3 . . . , a, b, c . . . , A, B, C . . . , X, Y, Z . . . , i, ii, iii . . . , or the like, and may be determined according to predetermined conditions.

Next, the reference confirmation module 103 may search the order letters in the article header information 112h that are referred to in the article body information 112t of the unit information 112 (S5), and if the order letter that is confirmed as an error by the order confirmation module 102 is referred to (Yes at S6), the reference confirmation module 103 may extract the order letter in the article body information 112t as an error (S7). For example, in the article body 112t₇₂ illustrated in FIG. 4, “Article 1 to Article 6” includes the “Article 3” extracted at step S4. Hence, the reference confirmation module 103 extracts the article body 112t₇₂ as an error.

Moreover, the reference confirmation module 103 may search the order letters in the article header information 112h that are referred to in the article body information 112t of the unit information 112 (S5), and if the order letter not used in the article header information 112h is referred to (Yes at S8), the reference confirmation module 103 may extract the order letter in the article body information 112t as an error (S9). For example, if “Article 8 and Article 9” in the article body 112t₇₂ illustrated in FIG. 4 are not used in the article header information 112h, the reference confirmation module 103 extracts the article body 112t₇₂ as an error.

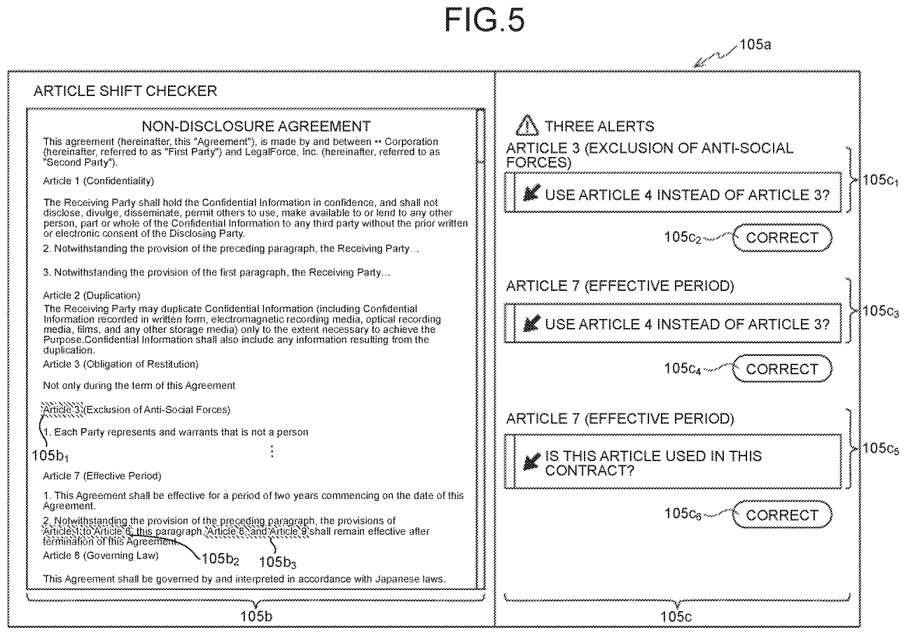

Next, the output control module 105 may output alerts to the order letter in the article header information 112h extracted as an error at step S4, and the order letters referred to in the article body information 112t that are extracted as errors at steps S7 and S9, via the communication unit 12. Then, as illustrated in the following FIG. 5, the output control module 105 may display the alerts on the display unit of the terminal 2 (S10).

FIG. 5 is a schematic diagram illustrating a configuration example of a screen displayed on a display unit of the terminal 2.

A screen 105a may include a document information display area 105b that indicates highlights 105b₁, 105b₂, and 105b₃ corresponding to alerts in addition to the contents of the document information 111, and an alert display area 105c that indicates an alert 105c₁ and a correction button 105c₂, an alert 105c₃ and a correction button 105c₄, and an alert 105c₅ and a correction button 105c₆.

On the screen 105a described above, when one of the alert 105c₁, alert 105c₃, and alert 105c₅ is selected by the user operation, the corresponding highlights 105b₁, 105b₂, or 105b₃ may be highlighted to emphasize the corresponding relation. Similarly, when one of the highlights 105b₁, 105b₂, and 105b₃ is selected, the alert 105c₁, alert 105c₃, or alert 105c₅ may be highlighted.

As the contents of the alert 105c₁, alert 105c₃, and alert 105c₅, on a part where the order letter is not in ascending order or serially numbered, the output control module 105 may present a correction candidate corresponding to the ascending order and serial number, and on a part where the order letter is referred to but is not used in the article header information 112h, the output control module 105 may present a message asking the user to confirm whether the order letter is used.

Moreover, as the contents of the alert, in a case where multiple order letters may be considered as candidates, the output control module 105 may separately provide operation display items for a pull-down display or the like, by presenting the order letters and allowing the user to select therefrom. Furthermore, if a certain order letter is duplicated or missing, and all the subsequent order letters need to be moved up or down, a message indicating that the subsequent order letters need to be rearranged may be displayed as an alert, and the subsequent order letters may be rearranged by selecting a correction button. Still furthermore, when there is a possibility that the order letter to be referred to in the article body information 112t may be shifted, a new alert will be displayed.

Still furthermore, the output control module 105 may be display the correction button 105c₂, correction button 105c₄, and correction button 105c₆ for confirming whether the order letters are to be corrected by the contents of the alert 105c₁, alert 105c₃, and alert 105c₅, and when the correction button 105c₂, correction button 105c₄, and correction button 105c₆ are selected and operated by the user, the following “(3) Correction Reflection Operation” may be executed.

### (3) Correction Reflection Operation

Next, the user may confirm the contents of the alerts on the screen 105a, operates the terminal 2, and selects a desired button among the correction button 105c₂, correction button 105c₄, and correction button 105c₆ to request a correction.

The terminal 2 may send a correction request to the document processing server device 1 with the selected content.

The correction module 104 of the document processing server device 1 may receive the request from the terminal 2 and receive the correction selected by the user (S11). When a correction instruction is issued, the correction module 104 may correct the order letter in the document information 111 and/or unit information 112 with the correction candidate (S12).

According to the embodiment described above, the document information 111 may be divided into the unit information 112 in predetermined units, the order letters contained in the unit information 112 may be extracted from the article header information 112h, and after confirming whether the order letters are in ascending order and serially numbered according to a predetermined rule, an alert may be output when the order letter is not in ascending order and serially numbered. Hence, it is possible to reduce the step of confirming the order of the predetermined units in the document, within the document.

Moreover, a letter referring to the order letter may be extracted from the article body information 112t of the unit information 112, and when the order letter corresponding to the letter is the order letter not in ascending order and serially numbered, an alert may be output to the letter corresponding to the order letter. Hence, it is possible to reduce the step of confirming the letter referring to the order letter, in addition to confirming the order of the predetermined units in the document, within the document.

Furthermore, the letter referring to the order letter may be extracted from the article body information 112t of the unit information 112, and an alert may output to the letter corresponding to the order letter, when the order letter corresponding to the letter is not present in the article header information 112h. Hence, it is possible to reduce the step of confirming the letter referring to the order letter, in addition to confirming the order of the predetermined units in the document, within the document.

### Other Embodiments

Various modifications may be made without departing from the scope of the present invention.

For example, in the embodiment described above, whether the order letters are in ascending order and serially numbered according to a predetermined rule is confirmed. However, only the ascending order may be confirmed, or only the serial number may be confirmed. Moreover, any order such as skipping one, skipping two, or the like may be set for a predetermined rule.

Moreover, in the embodiment described above, an alert is output to the erroneous order number, and correction is made when the correction button is operated. However, correction may also be made without operation, and an output of correction history to the corrected part may be regarded as an alert. Furthermore, only the document information display area 105b including the highlight display may be displayed as an alert, without displaying the alert display area 105c. Still furthermore, in this case, a “correction button” may be provided in the document information display area 105b, and correction may be made when the “correction button” is operated.

Still furthermore, in the embodiment described above, the document processing server device 1 functions as an information processing device. However, it is not limited thereto, and the processing executed by the document processing server device 1 and information stored in the document processing server device 1 may be distributed to other server devices, and the document processing server device 1 and the other server devices may function as an information processing device in an integral manner. Still furthermore, the terminal 2 or terminal 3 may also function as an information processing device to perform each process.

Still furthermore, in the embodiment described above, the article unit is mainly used as the division module of the document information, and the order is confirmed by the article unit. However, the section unit and the item unit may also be used as the division module, or the order may be confirmed by a combination of the article unit, the section unit, and the item unit.

Still furthermore, in the embodiment described above, an alert is mainly output to the terminal 2 or terminal 3 via the communication unit of the document processing server device 1, and the alert is displayed on the display unit of the terminal 2 or 3. However, such an alert may be notified to the user by any method, and any method may be used. Still furthermore, if the terminal 2 or terminal 3 functions as a document processing device, an alert may be output to an external display, or may be output directly to the user's display unit.

In the embodiment described above, the functions of the units 100 to 104 of the control unit 10 are implemented by a computer program. However, all or part of the units may also be implemented by hardware such as an application-specific integrated circuit (ASIC). Moreover, the computer program used in the embodiment described above may be provided by storing the computer program in a recording medium such as a compact disc read-only memory (CD-ROM). Furthermore, replacement, deletion, addition, or the like of the above-mentioned steps described in the above embodiments are possible within a range that does not change the gist of the present invention.

Provided are a computer program product, an information processing device, and a document processing method that reduce the step of confirming the order of a predetermined unit in a document, within the document.

According to various embodiments in the present disclosure, it is possible to provide a more user-friendly computer program product, an information processing device, and a document processing method.

According to the information processing device disclosed in Japanese Patent Publication No. H07-271793 described above, when the order of the serial numbers already input in the serial number area is disturbed, the user needs to operate the device to indicate the serial number area, even when the numbers or specific symbols with the selected form are sequentially input to predetermined positions in the serial number area and the serial numbers are reassigned according to a predetermined order of the stored form to satisfy the set condition.

The present embodiments can provide a user-friendly computer program product, an information processing device, and a document processing method to solve the problem described above.

For the embodiments described above, the following Notes are disclosed, as aspects and selective features of the inventions.

Note. 1

According to another aspect of an embodiment, a computer program product comprises a computer-readable medium including programmed instructions, the instructions causing a computer to execute:
dividing document information by a predetermined unit into units information; and
extracting, from the units information, order letters for defining an order of the units information in the document information, confirming whether the order letters are in ascending order and serially numbered according to a predetermined rule in the document information, and outputting, among the units information, an alert to unit information that is not in ascending order and serially numbered.

Note. 2

The instructions cause the computer to execute searching a main body of the unit information, which is not in ascending order and serially numbered, for a letter corresponding to the order letter in the unit information, and outputting an alert to the unit information.

Note. 3

The instructions cause the computer to execute extracting letters corresponding to the order letters from main bodies of the units information, and outputting an alert to a letter that is not present in the order letters among the extracted letters.

Note. 4

The instructions cause the computer to execute:
outputting correction candidates with respect to the order letters and/or letters corresponding to the order letters based on the predetermined rule in the alert; and
correcting, by a correction candidate selected from the correction candidates, the corresponding order letter and/or a letter corresponding to the order letter.

Note. 5

The computer is communicably connected to one or a plurality of terminals via a network.

Note. 6

The computer is connected to one or a plurality of terminals via a wireless communication network.

Note. 7

According to another aspect of an embodiment, an information processing device, includes:
a memory configured to store document information in addition to predetermined instructions; and
a processor configured to: based on the instructions stored in the memory,
   divide the document information by a predetermined unit into units information; and
   extract, from the units information, order letters for defining an order of the units information in the document information, confirm whether the order letters are in ascending order and serially numbered according to a predetermined rule in the document information, and output, among the units information, an alert to unit information that is not in ascending order and serially numbered.

Note. 8

According to another aspect of an embodiment, a document processing method, comprises:
dividing document information by a predetermined unit into units information; and
extracting, from the units information, order letters for defining an order of the units information in the document information, confirming whether the order letters are in ascending order and serially numbered according to a predetermined rule in the document information, and outputting an alert to unit information that is not in ascending order and serially numbered.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. All such modifications as would be apparent to one of ordinary skill in the art are intended to be included within the scope of the following claims. The accompanying claims and their equivalents are intended to cover such forms or modifications as would fall within the scope and spirit of the inventions.

What is claimed is:

1. A document processing method for causing a processor to execute a process, the document processing method comprising executing on the processor the steps of:
confirming whether order letters are in an ascending order and serially numbered according to a predetermined rule in document information, the order letters being extracted from units information and defining an order of the units information in the document information, the units information being generated by diving the document information by a predetermined unit; and
outputting alert information including a correction candidate which shows the order letters being in the ascending order and serially numbered.

2. The document processing method according to claim 1, further comprising:
searching a main body of the units information, which is not in the ascending order and serially numbered, for a letter corresponding to the order letter in the units information.

3. The document processing method according to claim 1, further comprising:
extracting letters corresponding to the order letters from a main body of the units information; and
outputting the alert information to a letter that is not present in the order letters among the extracted letters.

4. The document processing method according to claim 1, further comprising:
outputting a correction candidate with respect to the order letters and/or letters corresponding to the order letters based on the predetermined rule; and
correcting, by the correction candidate, the corresponding order letter and/or a letter corresponding to the order letter.

5. The document processing method according to claim 1, further comprising:
sending the alert information to one or a plurality of user terminals via a network.

6. The document processing method according to claim 5, further comprising:
reviewing the document information and the alert information by a user via one or the plurality of user terminals.

7. The document processing method according to claim 1,
wherein the document information is contract document information.

8. The document processing method according to claim 1,
wherein the order letter includes at least two levels, and
in the confirming, it is confirmed whether the order letter is in the ascending order and serially numbered at each level of the at least two levels.

9. The document processing method according to claim 1,
wherein the document information includes article header information that shows a letter for defining the order of articles.

10. The document processing method according to claim 9,
wherein in the confirming, it is confirmed whether the order letter is in the ascending order and serially numbered based on the article header information.

11. The document processing method according to claim 1, further comprising:
displaying the document information and the alert information in parallel.

12. The document processing method according to claim 1,
wherein the alert information further includes, if a certain order letter is duplicated or missing and all the subsequent order letters need to be moved up or down, a message indicating that subsequent order letters need to be rearranged.

13. An information processing device comprising:
a memory configured to store a program and document information; and
a processor configured to execute the program so as to: confirm whether order letters are in an ascending order and serially numbered according to a predetermined rule in the document information, the order letters being extracted from units information and defining an order of the units information in the document information, the units information being generated by diving the document information by a predetermined unit; and
output alert information including a correction candidate which shows the order letters being in the ascending order and serially numbered.

14. The information processing device according to claim 13,
wherein the processor is further configured to:
search a main body of the units information, which is not in the ascending order and serially numbered, for a letter corresponding to the order letter in the units information.

15. The information processing device according to claim 13,
wherein the processor is further configured to:
extract letters corresponding to the order letters from a main body of the units information; and
output the alert information to a letter that is not present in the order letters among the extracted letters.

16. The information processing device according to claim 13,
wherein the processor is further configured to:
output a correction candidate with respect to the order letters and/or letters corresponding to the order letters based on the predetermined rule; and
correct, by the correction candidate, the corresponding order letter and/or a letter corresponding to the order letter.

17. The information processing device according to claim 13,
wherein the processor is further configured to:
send the alert information to one or a plurality of user terminals via a network.

18. The information processing device according to claim 17,
wherein the document information and the alert information are reviewed by a user via one or the plurality of user terminals.

19. The information processing device according to claim 13,
wherein the document information is contract document information.

20. The information processing device according to claim 13,
wherein the order letter includes at least two levels, and
the processor is further configured to confirm whether the order letter is in the ascending order and serially numbered at each level of the at least two levels.
